(19) United States
(12) Patent Application Publication
(10) Pub. No.: US 2010/0092798 A1
(43) Pub. Date: Apr. 15, 2010

(54) Submerged arc weld metal for 1.25 Cr-0.5 Mo steel, coke drum and bonded flux

(75) Inventors: Yasuhiko Sasaki, Ehime (JP); Shinta Niimoto, Ehime (JP); Satoshi Nishimura, Tiba (JP); Yoshiaki Murata, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: SUMITOMO HEAVY INDUSTRIES, LTD., Tokyo (JP)

(21) Appl. No.: 12/588,265

(22) Filed: Oct. 9, 2009

(30) Foreign Application Priority Data
Oct. 10, 2008 (JP) 2008-264290

(51) Int. Cl. C22C 38/12; C22B 9/10; B32B 15/02

(52) U.S. Cl. 428/657; 420/123; 420/124; 75/329; 428/683

(57) ABSTRACT

A high-quality submerged arc weld metal for 1.25 Cr-0.5 Mo steel that is obtained by carrying out multi-pass welding in a submerged arc welding process with a solid wire and a bonded flux being combined together, is produced in which a strength mismatch with a base material does not occur even after a Post Weld Heat Treatment is carried out for a short time to a long time, and which has high ductility as well as having no weld defect. The submerged arc weld metal for 1.25 Cr-0.5 Mo steel is characterized in that: the weld metal contains, per the total mass of the weld metal, C: 0.06 to 0.12 mass %, Si: 0.15 to 0.30 mass %, Mn: 0.60 to 1.10 mass %, Cr: 1.10 to 1.45 mass % and Mo: 0.45 to 0.60 mass %, wherein O is contained in an amount of 0.022 mass % or less and N is contained in an amount of 0.008 mass % or less, and wherein the balance is Fe and inevitable impurities.

### BACKGROUND OF THE INVENTION

1. Field of the Invention

The present invention relates to a weld metal obtained by carrying out multi-pass welding on 1.25 Cr-0.5 Mo steel in a submerged arc welding process, and a bonded flux for the weld metal, and more particularly, to a high-quality submerged arc weld metal for 1.25 Cr-0.5 Mo steel in which a strength mismatch with a base material does not occur even after a Post Weld Heat Treatment (hereinafter, referred to as a PWHT) is carried out for a short time to a long time, and which has stable high ductility as well as having no weld defect, and a bonded flux for the weld metal.

2. Description of the Related Art

1.25 Cr-0.5 Mo steel is widely used for boiler drums, various steel pipes such as main steam pipes and heating steam pipes, and apparatuses in the petrochemical industry, etc.

In general, Cr—Mo low-alloy steels have been put to practical use as materials excellent in high-temperature oxidation resistance and high-temperature characteristics. Among the Cr—Mo alloy steels, 1.25 Cr-0.5 Mo steel, 2.25 Cr-1 Mo steel and 3 Cr-1 Mo steel, etc., have been appropriately selected in accordance with their use conditions. In particular with respect to 2.25 Cr-1 Mo steel and 3 Cr-1 Mo steel, improved steel materials to which V is added have been developed, in which high-temperature strength and hydrogen attack resistance thereof are improved in order to be used at high temperature and pressure; and weld materials for the improved steel materials have also been put to practical use.

On the other hand, with respect to 1.25 Cr-0.5 Mo steel, a weld metal for the steel has been requested to have high ductility at low temperature and not to cause a strength mismatch between the weld metal and a base material, taking into consideration operations and brittle fracture during out-of-operation periods in cold areas, although there has been no need for the steel to be used at high temperature and pressure. Further, it is specified in the WES 1109: “Guideline for crack-tip opening displacement (CTOD) fracture toughness test method of weld heat affected zone” that an allowance for the strength mismatch is up to approximately 10 to 15% to the strength of the base material.

A PWHT condition is a major factor affecting the ductility of a weld metal. The PWHT is carried out in order to remove a residual stress of a weld zone generated by welding and to improve the ductility of the weld zone. When the PWHT is carried out for a short time, the ductility of the weld metal becomes low; and when carried out for a long time, the ductility thereof becomes higher as the strength thereof is decreased. However, when being carried out for too long a time, the ductility thereof becomes low, and hence the PWHT must be carried out at an appropriate temperature and for an appropriate time. In general, the PWHT is carried out one to five times at a temperature of 690° C.±20° C., and the total period when the PWHT is performed ranges over a wide range of 3 to 25 hours. The higher the temperature, or the longer the period even at the same temperature, the greater an annealing effect. As a value indicating the degree of the annealing effect, the parameter T·P shown in the following equation is widely used: T·P=T{20+log(t)}×10⁻³, where T=temperature (° K.) and t=period (hr). The T·P in an welding operation of 1.25 Cr-0.5 Mo steel generally ranges from 19.3 to 20.9.

Techniques with respect to submerged arc welding of 1.25 Cr-0.5 Mo steel are disclosed in some Patent Documents, for example: Japanese Patent Application Publication No. S58-58982 discloses a technique in which the high ductility is obtained by forming a lot of AlN in the weld metal to make the grain size of weld metal fine; Japanese Patent Application Publication No. S59-73194 discloses one in which the high ductility is obtained by combining a fused flux with a wire containing a lot of V; and Japanese Patent Application Publication No. S59-82189 discloses one in which the weld metal having the high ductility and the high strength is obtained by adding, as components of a wire, B and N as essential components and at least one of Ti, Zr and Al.

However, in each technique disclosed in the aforementioned Patent Documents, the ductility of the weld metal has been evaluated after the PWHT was carried out to some extent for a long time, and the strength mismatch between the weld metal and the base material is not taken into consideration. Further, an oxygen content in the weld metal is high due to a component composition of the flux thus combined, and the ductility of the weld metal in which the PWHT has been carried out for a short time, is varied at a low temperature, causing the weld metal to be unsatisfactory. The weld metal is also unsatisfactory in terms of weldability and weld defect resistance.

### SUMMARY OF THE INVENTION

A purpose of the present invention is to provide a high-quality submerged arc weld metal for 1.25 Cr-0.5 Mo steel that is obtained by carrying out multi-pass welding in a submerged arc welding process with a solid wire and a bonded flux being combined together, in which a strength mismatch between the weld metal and a base material does not occur even after the PWHT is carried out for a short time to a long time, and which has high ductility as well as having no weld defect.

The gist of the present invention is characterized in that, in a weld metal obtained by carrying out multi-pass welding in a submerged arc welding process with a solid wire and a bonded flux being combined together, the weld metal contains, per the total mass of the weld metal, C, 0.06 to 0.12 mass %, Si: 0.15 to 0.30 mass %, Mn: 0.60 to 1.10 mass %, Cr: 1.10 to 1.45 mass % and Mo: 0.45 to 0.60 mass %, wherein 0 is contained in an amount of 0.022 mass % or less and N is contained in an amount of 0.008 mass % or less, and wherein the balance is Fe and inevitable impurities. Also, the gist of the invention is characterized in that the total of at least one of Ti, V and Nb is contained in an amount of 0.005 to 0.02 mass %.

Also, the gist of the invention is characterized in that a bonded flux to be combined contains, per the total mass of the flux, MgO: 25 to 35 mass %, Al₂O₃: 13 to 20 mass %, CaF₂: 14 to 22 mass %, SiO₂: 10 to 19 mass %, CaO: 6 to 12 mass % and a CO₂ conversion value of metal carbonates: 3 to 5 mass %, wherein the balance is Na₂O, K₂O, an alloy agent, a deoxidizing agent and inevitable impurities.

According to the submerged arc weld metal for 1.25 Cr-0.5 Mo steel of the present invention, a high-quality submerged arc weld metal for 1.25 Cr-0.5 Mo steel, the submerged arc weld metal being obtained by carrying out multi-pass welding in a submerged arc welding process with a solid wire and a bonded flux being combined together, can be provided, in which the strength mismatch with the base material does not occur even after the PWHT is carried out for a short time to a long time, and which has the stable high ductility as well as having no weld defect.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a view schematically illustrating an example of a coke drum.

### DETAILED DESCRIPTION OF THE DRAWINGS

To solve the aforementioned problems, the present inventors have intensively studied the following issues after various weld metals have been formed by combing various solid wires and bonded fluxes together: an influence by a component composition of the weld metal on the strength mismatch with the base material and the ductility of the weld metal; and a component composition of the bonded flux affecting the defect resistance of the weld metal. As a result, the inventors have found a weld metal in which the strength mismatch with the base material does not occur even after the PWHT is carried out for a short time to a long time, and which has the high ductility; and have further found a high-quality submerged arc weld metal for 1.25 Cr-0.5 Mo steel, which does not have any weld defect.

Hereinafter, chemical components contained in the submerged arc weld metal for 1.25 Cr-0.5 Mo steel of the present invention, and reasons for limiting the composition of the weld metal, will be described.

### (C, 0.06 to 0.12 Mass %)

C has an effect of enhancing hardenability of a weld metal to adjust yield strength (0.2% offset yield strength) thereof and improve ductility thereof. When the content of C is less than 0.06 mass % (hereinafter, referred to %), the ductility thereof after the PWHT is carried out for a short time (hereinafter, referred to as PWHT1) is low, and the yield strength thereof also becomes low, resulting in being lower than the yield strength of the base material. On the other hand, when the content thereof is more than 0.12%, the ductility after the PWHT1 becomes low, and the yield strength becomes high, resulting in the strength mismatch with the base material. Further, a hot crack is likely to occur.

### (Si: 0.15 to 0.30%)

Si improves the ductility of a weld metal. When the content of Si is less than 0.15%, the ductility after the PWHT1 or after the PWHT is carried out for a long time (hereinafter, referred to as PWHT2), becomes low. On the other hand, when the content thereof is more than 0.30%, the yield strength becomes high, resulting in the strength mismatch with the base material and causing the ductility after the PWHT1 or the PWHT2 to be low.

### (Mn: 0.60 to 1.10%)

Mn enhances the hardenability of the weld metal to adjust the yield strength and to improve the ductility. When the Content of Mn is less than 0.60%, the ductility after the PWHT1 or the PWHT2 becomes low, and the yield strength becomes low, resulting in being lower than the yield strength of the base material. On the other hand, when the content is more than 1.10%, the yield strength becomes high, resulting in the strength mismatch with the base material and causing the ductility after the PWHT1 to be low.

### (Cr: 1.10 to 1.45%, Mo: 0.45 to 0.60%)

Because the present invention is intended to handle 1.25 Cr-0.5 Mo steel, each of Cr and Mo is requested to be contained in the weld metal in an amount corresponding to that in the base material in order to maintain the oxidation resistance and the creep resistance thereof. When the content of Cr is less than 1.10% and that of Mo is less than 0.45%, the yield strength becomes low, resulting in being lower than that of the base material. On the other hand, when the content of Cr is more than 1.45% and that of Mo is more than 0.60%, the hardenability becomes large and the yield strength becomes high, resulting in the strength mismatch with the base material and causing the ductility after the PWHT1 to be low.

### (O: 0.022% or Less)

O is present as oxides (non-metal inclusions) with Si, Mn, Cr and Ti, etc. When the content of 0 is more than 0.022%, stable ductility cannot be obtained after the PWHT1 or the PWHT2.

### (N: 0.008% or Less)

Excessive N makes the ductility after the PWHT1 or the PWHT2 unstable. Accordingly, N is to be contained in an amount of 0.008% or less.

### (Total of at Least One of Ti, V and Nb: 0.005 to 0.02%)

Ti is present as an oxide in the weld metal, and improves the ductility by making the grain size of weld metal fine. V and Nb generate carbides with C, and improve the ductility by making the grain size of weld metal fine. When the total content of at least one of Ti, V and Nb is less than 0.005%, an effect of improving the ductility cannot be obtained. On the other hand, when the total content thereof is more than 0.02%, oxides and carbides are generated in excessive amounts, causing in particular the ductility after the PWHT1 to be low.

Besides the components stated above, P, As, Sb and Sn are preferably contained in amounts as small as possible, taking into consideration embrittlement of the weld metal in operations.

Subsequently, a component composition of the bonded flux to be combined with the solid wire in order to obtain a weld metal having the aforementioned component composition and a high-quality weld metal not having any weld defect, will be described.

### (MgO: 25 to 35%)

MgO improve the ductility by lowering the oxygen content in the weld metal. When the content of MgO is less than 25%, oxygen is contained in a large amount in the weld metal, causing the ductility after the PWHT1 or the PWHT2 to be unstable. On the other hand, when the content thereof is more than 35%, the melting point of a molten slag becomes too high such that a bead does not spread, and slag detachability also becomes poor, causing a defect of slag inclusion in the multi-pass welding.

### (Al₂O₃: 13 to 20%)

Al₂O₃ forms a bead having a large bead width and a stable shape. When the content of Al₂O₃ is less than 13%, the shape at the bead toe becomes poor, causing the defect of slag inclusion in the multi-pass welding. On the other hand, when the content thereof is more than 20%, the bead has a convex shape, not allowing the multi-pass welding to be carried out.

### (CaF₂: 14 to 22%)

CaF₂ improves the ductility by lowering the oxygen content in the weld metal. When the content of CaF₂ is less than 14%, oxygen is contained in a large amount in the weld metal, causing the ductility after the PWHT1 or the PWHT2 to be unstable. On the other hand, when the content thereof is more than 22%, the arc becomes unstable, causing the defect of slag inclusion to likely occur.

### (SiO₂: 10 to 19%)

SiO₂ increases the viscosity of the slag and forms a bead having a stable shape at the bead toe. When the content of SiO₂ is less than 10%, the shape at the bead toe becomes poor, causing the defect of slag inclusion in the multi-pass welding. On the other hand, when the content is more than 19%, oxygen is contained in a large amount in the weld metal, causing the ductility after the PWHT1 or the PWHT2 to be unstable.

### (CaO: 6 to 12%)

CaO improves the ductility by lowering the oxygen content in the weld metal. When the content of CaO is less than 6%, oxygen is contained in a large amount in the weld metal, causing the ductility after the PWHT1 or the PWHT2 to be unstable. On the other hand, when the content thereof is more than 12%, the bead has a convex shape, not allowing the multi-pass welding to be carried out. It is noted that CaO includes that generated by decomposition of CaCO₃.

### (CO₂ Conversion Value of Metal Carbonates: 3 to 5%)

Metal carbonates such as CaCO₃ and BaCO₃ Dissociate into CO₂ gas in an arc atmosphere during welding, and reduces an amount of hydrogen migrating into the weld metal by lowering a hydrogen partial pressure in the arc atmosphere, reducing an amount of diffusible hydrogen and making the arc stable. When a CO₂ conversion value of metal carbonates is less than 3%, the amount of diffusible hydrogen in the weld metal becomes large, causing a cold cracking by hydrogen to likely occur. Also, the arc becomes unstable. On the other hand, when the value is more than 5%, the arc blows up and thereby the bead shape becomes bad, causing the defect of slag inclusion to likely occur.

The bonded flux contains, besides the aforementioned component composition, Na₂O and K₂O that are arc stabilizers, an alloy agent and a deoxidizing agent. If these components are contained in only the solid wire, an amount of alloys in the solid wire becomes large to make the wire hard, thereby causing production of the wires to be difficult and transmittability of the wire during the welding to be poor. Accordingly, the alloy agent and the deoxidizing agent may be contained in the bonded flux such that the weld metal has the intended components.

C to be contained in the bonded flux may have the forms of an alloy powder such as high carbon Fe—Mn, and graphite, etc.; Si the forms of metal Si, Fe—Si and Si—Mn, etc.; Mn the forms of metal Mn, Fe—Mn and Si—Mn, etc.; Cr the forms of metal Cr, Fe—Cr, etc.; Mo the forms of metal Mo and Fe—Mo, etc.; V the form of Fe—V; Nb the form of Fe—Nb; and Ti the forms of metal Ti and Fe—Ti, etc.

The solid wire to be combined therewith preferably has components in amounts of C, 0.05 to 0.12%, Si: 0.10 to 0.35%, Mn: 0.60 to 1.10%, P: 0.010% or less, S: 0.010% or less, Cr: 1.20 to 1.50%, Mo: 0.45 to 0.60%, Ti: 0.015% or less, V: 0.015% or less and Nb: 0.015% or less.

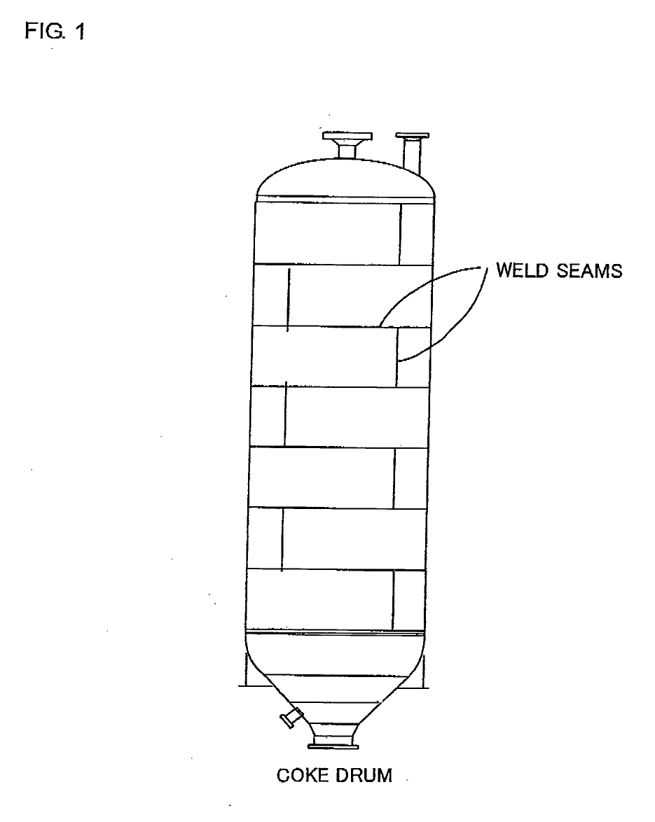

A coke drum means a cylindrical reactor used in the process (delayed coking method) where, in the petroleum refining process, the heavy oil is cracked into gases and petroleum cokes by thermal cracking. The coke drum is produced by building up a heat-resistant steel (chrome-molybdenum steel) that can be proof against operations at high temperature and pressure, with the submerged arc welding. In the process operation, heat cycles are repeated in which the temperature is elevated to approximately 500° C. and then cooled to approximately 100° C., and hence many damages to welded portions have been reported. If such a coke drum is produced by using the submerged arc weld metal for 1.25 Cr-0.5 Mo steel according to the present invention, a coke drum can be obtained in which the submerged arc weld metal has no mismatch with the base material, has high ductility, has no weld defect and has high durability. FIG. 1 illustrates a usage state of the coke drum, as viewed from its side. The submerged arc weld metal for 1.25 Cr-0.5 Mo steel and the bonded flux for obtaining the weld metal, according to the present invention, are used for joining together the upper part, the side part and the lower part of the coke drum.

### Example

Hereinafter, the effects of the present invention will be described in more detail.

Combining the solid wires (wire diameter 4.8 mm) shown in Table 1 with the bonded fluxes (particle size 300×100 μm) shown in Table 2, the multi-pass welding was carried out for a weld length of 750 mm using the steel plate (1.25 Cr-0.5 Mo steel) having components shown in Table 3 as a groove with a backing plate, the upper surface of the groove having a width of 25 mm and the gap thereof having a width of 24 mm, in one-layer-two passes method under the welding conditions shown in Table 4.

TABLE 1

| WIRE | WIRE COMPONENTS (MASS %) | | | | | | | | | | |
|---|---|---|---|---|---|---|---|---|---|---|---|
| SYMBOL | C | Si | Mn | P | S | Cr | Mo | N | Ti | V | Nb |
| W1 | 0.08 | 0.15 | 0.85 | 0.006 | 0.003 | 1.35 | 0.52 | 0.0064 | 0.008 | — | — |
| W2 | 0.07 | 0.22 | 0.72 | 0.008 | 0.005 | 1.42 | 0.48 | 0.0051 | — | — | — |
| W3 | 0.05 | 0.18 | 0.62 | 0.007 | 0.004 | 1.47 | 0.53 | 0.0072 | 0.015 | — | — |
| W4 | 0.09 | 0.10 | 0.76 | 0.007 | 0.004 | 1.39 | 0.49 | 0.0066 | — | 0.01 | — |
| W5 | 0.06 | 0.32 | 0.98 | 0.005 | 0.007 | 1.28 | 0.55 | 0.0057 | — | — | — |
| W6 | 0.12 | 0.25 | 1.02 | 0.006 | 0.006 | 1.21 | 0.51 | 0.0048 | 0.012 | — | 0.012 |
| W7 | 0.09 | 0.12 | 0.91 | 0.004 | 0.004 | 1.39 | 0.57 | 0.0068 | — | — | — |
| W8 | 0.10 | 0.18 | 0.76 | 0.007 | 0.005 | 1.41 | 0.45 | 0.0041 | — | 0.012 | 0.008 |
| W9 | 0.03 | 0.15 | 0.68 | 0.005 | 0.004 | 1.38 | 0.51 | 0.0064 | — | — | — |
| W10 | 0.07 | 0.22 | 1.32 | 0.006 | 0.004 | 1.39 | 0.49 | 0.0058 | — | — | — |
| W11 | 0.06 | 0.19 | 0.91 | 0.007 | 0.006 | 1.55 | 0.54 | 0.0065 | 0.008 | — | — |
| W12 | 0.08 | 0.14 | 0.82 | 0.005 | 0.004 | 1.02 | 0.51 | 0.0055 | — | 0.005 | — |
| W13 | 0.09 | 0.20 | 0.76 | 0.008 | 0.003 | 1.35 | 0.41 | 0.0061 | 0.01 | 0.009 | 0.01 |
| W14 | 0.05 | 0.26 | 0.84 | 0.006 | 0.004 | 1.39 | 0.64 | 0.0054 | 0.014 | — | — |
| W15 | 0.06 | 0.19 | 0.69 | 0.007 | 0.005 | 1.42 | 0.52 | 0.0091 | — | — | — |

TABLE 2

| | FLUX COMPONENTS (MASS %) | | | | | | | | | | | | |
|---|---|---|---|---|---|---|---|---|---|---|---|---|---|
| | | | | | | CO₂ | | | | | | | |
| FLUX | | | | | | CONVERSION | | | | | | | |
| SYMBOL | M₂O | AI₂O₂ | CaF₂ | SiO₂ | CaO | VALUE | C | Si | Mn | Ti | V | Nb | OTHERS |
| F1 | 29.2 | 15.4 | 18.8 | 15.2 | 8.5 | 4.2 | 0.02 | 0.81 | 1.12 | — | — | — | BALANCE |
| F2 | 25.8 | 19.5 | 18.2 | 14.6 | 9.7 | 3.8 | 0.04 | 0.84 | 0.84 | 0.15 | — | — | |
| F3 | 34.2 | 14.5 | 15.8 | 16.6 | 9.3 | 4.5 | 0.01 | 0.57 | 0.21 | — | — | — | |
| F4 | 32.6 | 19.2 | 21.7 | 10.4 | 8.9 | 3.2 | 0.05 | 0.14 | 0.92 | — | — | 0.05 | |
| F5 | 32.9 | 16.9 | 14.5 | 14.5 | 11.2 | 4.0 | 0.03 | 0.33 | 0.82 | — | — | — | |
| F6 | 29.8 | 15.9 | 17.8 | 13.9 | 11.5 | 4.5 | 0.01 | 0.68 | 1.06 | — | — | — | |
| F7 | 31.4 | 13.3 | 21.7 | 11.7 | 10.8 | 3.6 | 0.05 | 0.59 | 0.92 | — | — | — | |
| F8 | 30.8 | 16.4 | 17.2 | 14.2 | 8.8 | 5.8 | 0.02 | 0.94 | 1.14 | — | — | — | |
| F9 | 28.8 | 17.4 | 19.2 | 16.3 | 9.2 | 2.1 | 0.08 | 0.57 | 0.88 | — | — | — | |
| F10 | 34.1 | 18.1 | 17.4 | 9.1 | 11.1 | 4.1 | 0.01 | 0.15 | 0.72 | 0.11 | — | — | |
| F11 | 26.8 | 15.5 | 23.3 | 16.6 | 8.9 | 3.5 | 0.02 | 0.92 | 1.24 | — | — | — | |
| F12 | 26.2 | 11.7 | 20.9 | 18.2 | 11.3 | 4.4 | 0.05 | 0.71 | 0.23 | 0.05 | 0.02 | — | |
| F13 | 37.1 | 13.8 | 17.5 | 10.9 | 10.7 | 3.5 | 0.04 | 0.51 | 1.05 | — | — | — | |
| F14 | 23.5 | 18.4 | 20.7 | 18.1 | 8.7 | 3.2 | 0.03 | 0.48 | 0.78 | — | — | — | |
| F15 | 32.4 | 19.7 | 12.6 | 15.2 | 7.6 | 4.6 | 0.02 | 0.59 | 0.87 | — | — | — | |
| F16 | 26.6 | 18.5 | 18.4 | 20.7 | 7.8 | 3.1 | 0.01 | 0.62 | 0.98 | — | — | — | |
| F17 | 29.3 | 18.2 | 19.5 | 17.9 | 4.7 | 4.5 | 0.02 | 0.71 | 1.01 | — | — | — | |
| F18 | 29.2 | 21.1 | 17.6 | 15.7 | 8.1 | 4.5 | 0.01 | 0.88 | 1.27 | — | — | — | |
| F19 | 25.8 | 16.6 | 15.5 | 17.8 | 13.5 | 3.3 | 0.01 | 0.91 | 0.85 | — | — | — | |

1) alloy agent, deoxidizing agent C; C and Graphite in an alloy powder, Si: Fe—Si, Mn: Fe—Mn, Ti: Fe—Ti, V: Fe—V, Nb: Fe—Nb
2) Others; mainly consisting of FE from an alloy and a deoxidizing agent, an Na₂O and K₂O from a liquid glass

TABLE 3

| SHEET | | | | | | | |
|---|---|---|---|---|---|---|---|
| THICKNESS | STEEL SHEET COMPONENTS (MASS %) | | | | | | |
| (mm) | C | Si | Mn | P | S | Cr | Mo |
| 25 | 0.12 | 0.55 | 0.61 | 0.003 | 0.001 | 1.46 | 0.61 |

TABLE 4

| | | | | PREHEAT | INTERPASS |
|---|---|---|---|---|---|
| | CURRENT | VOLTAGE | SPEED | TEMPERATURE | TEMPERATURE |
| ELECTRODE | (A) | (V) | (cm/min) | (° C.) | (° C.) |
| PRECEDING | 620 | 32 | 58 | 200 | 200~250 |
| FOLLOWING | 620 | 32 | | | |

After the welding, X-ray radiographic tests were performed to investigate whether a weld defect occurs on weld metal. Thereafter, the test plate was divided into half to perform the PWHT under two conditions of the PWHT1 condition and PWHT2 condition shown in Table 5. Subsequently, analysis samples, round bar tensile specimens according to JIS Z 3111 A1 (No. 10 specimens according to JIS Z 2201) and impact specimens according to JIS Z 3111 A4 (No. 4 specimens according to JIS Z 2201), were taken from the central portion of the weld metal. Components of the weld metals are shown in Table 6.

TABLE 5

| PWHT | HOLDING | HOLDING | T · P |
|---|---|---|---|
| CONDITION No. | TEMPERATURE (° C.) | TIME (Hr) | (×10³) |
| PWHT1 | 690 | 3 | 19.72 |
| PWHT2 | 690 | 20 | 20.51 |

TABLE 6

| | WELD | | | | | | | | | | | | | | |
|---|---|---|---|---|---|---|---|---|---|---|---|---|---|---|---|
| | METAL | COMBINATION | | WELD METAL COMPONENTS (MASS %) | | | | | | | | | | | |
| SEGMENT | No. | WIRE | FLUX | C | Si | Mn | P | S | Cr | Mo | O | N | Ti | V | Nb |
| PRESENT | 1 | W1 | F4 | 0.10 | 0.16 | 0.89 | 0.008 | 0.005 | 1.28 | 0.52 | 0.0205 | 0.0068 | 0.004 | — | 0.004 |
| INVENTION | 2 | W2 | F1 | 0.08 | 0.24 | 0.87 | 0.009 | 0.007 | 1.37 | 0.48 | 0.0211 | 0.0057 | — | — | — |
| EXAMPLES | 3 | W3 | F7 | 0.08 | 0.21 | 0.65 | 0.008 | 0.005 | 1.43 | 0.52 | 0.0182 | 0.0076 | 0.009 | — | — |
| | 4 | W4 | F8 | 0.08 | 0.16 | 0.85 | 0.009 | 0.005 | 1.35 | 0.50 | 0.0195 | 0.0068 | — | 0.006 | — |
| | 5 | W5 | F5 | 0.08 | 0.29 | 1.05 | 0.007 | 0.008 | 1.27 | 0.54 | 0.0217 | 0.0081 | — | — | — |
| | 6 | W6 | F4 | 0.12 | 0.21 | 1.01 | 0.007 | 0.007 | 1.15 | 0.51 | 0.0188 | 0.0052 | 0.004 | — | 0.015 |
| | 7 | W7 | F3 | 0.09 | 0.17 | 0.75 | 0.005 | 0.006 | 1.35 | 0.55 | 0.0209 | 0.0073 | — | — | — |
| | 8 | W8 | F2 | 0.11 | 0.20 | 0.91 | 0.008 | 0.007 | 1.37 | 0.46 | 0.0181 | 0.0052 | 0.007 | 0.007 | 0.004 |
| | 9 | W3 | F4 | 0.07 | 0.18 | 0.71 | 0.008 | 0.006 | 1.43 | 0.52 | 0.0203 | 0.0075 | 0.005 | — | 0.012 |
| | 10 | W7 | F2 | 0.10 | 0.17 | 0.95 | 0.006 | 0.008 | 1.35 | 0.55 | 0.0215 | 0.0071 | 0.008 | — | — |
| COMPARATIVE | 11 | W9 | F8 | 0.04 | 0.21 | 0.87 | 0.006 | 0.004 | 1.32 | 0.51 | 0.0211 | 0.0065 | — | — | — |
| EXAMPLES | 12 | W6 | F9 | 0.14 | 0.18 | 1.04 | 0.007 | 0.007 | 1.17 | 0.50 | 0.0197 | 0.0049 | 0.004 | — | 0.001 |
| | 13 | W4 | F10 | 0.09 | 0.12 | 0.81 | 0.008 | 0.005 | 1.33 | 0.49 | 0.0188 | 0.0068 | 0.005 | 0.002 | — |
| | 14 | W5 | F11 | 0.07 | 0.34 | 1.01 | 0.006 | 0.007 | 1.24 | 0.54 | 0.0164 | 0.0059 | — | — | — |
| | 15 | W3 | F12 | 0.07 | 0.19 | 0.54 | 0.007 | 0.005 | 1.43 | 0.54 | 0.0208 | 0.0059 | 0.007 | 0.004 | — |
| | 16 | W10 | F13 | 0.08 | 0.24 | 1.25 | 0.007 | 0.005 | 1.38 | 0.49 | 0.0199 | 0.0059 | — | — | — |
| | 17 | W12 | F1 | 0.08 | 0.17 | 0.93 | 0.006 | 0.005 | 1.01 | 0.50 | 0.0187 | 0.0057 | — | 0.002 | — |
| | 18 | W11 | F2 | 0.08 | 0.21 | 0.99 | 0.006 | 0.007 | 1.51 | 0.53 | 0.0173 | 0.0068 | 0.011 | — | — |
| | 19 | W13 | F3 | 0.08 | 0.21 | 0.85 | 0.009 | 0.005 | 1.33 | 0.41 | 0.0203 | 0.0067 | 0.008 | 0.005 | 0.008 |
| | 20 | W14 | F4 | 0.09 | 0.28 | 0.93 | 0.008 | 0.008 | 1.32 | 0.63 | 0.0139 | 0.0058 | 0.005 | — | 0.008 |
| | 21 | W15 | F5 | 0.07 | 0.18 | 0.82 | 0.009 | 0.007 | 1.37 | 0.51 | 0.0211 | 0.0095 | — | — | — |
| | 22 | W1 | F14 | 0.09 | 0.18 | 0.69 | 0.007 | 0.005 | 1.30 | 0.52 | 0.0294 | 0.0087 | 0.005 | — | — |
| | 23 | W2 | F15 | 0.09 | 0.23 | 0.75 | 0.006 | 0.005 | 1.39 | 0.49 | 0.0316 | 0.0058 | — | — | — |
| | 24 | W7 | F16 | 0.08 | 0.17 | 0.92 | 0.006 | 0.005 | 1.34 | 0.56 | 0.0322 | 0.0071 | — | — | — |
| | 25 | W6 | F17 | 0.09 | 0.21 | 0.87 | 0.006 | 0.007 | 1.37 | 0.46 | 0.0309 | 0.0046 | — | 0.007 | 0.005 |

| | | | |
|---|---|---|---|
| 26 | W3 | F18 | HALT OF WELDING |
| 27 | W4 | F19 | HALT OF WELDING |

In the tensile test, a weld metal having the 0.2% offset yield strength of 480 to 520 MPa after the PWHT1, was evaluated good (the base material: 470 MPa), and that having the same of 440 to 470 MPa after the PWHT2, was done likewise (base material: 430 MPa); and in the impact test, a weld metal having the minimum absorbed energy of 136 J or more after the PWHT1 or the PWHT2, was evaluated good, the minimum absorbed energy being selected from five absorbed energies obtained from tests performed at temperature of −29° C. The results of the weldability, the X-ray radiographic tests, 0.2% offset yield strength of the tensile tests and the impact tests are collectively shown in Table 7.

TABLE 7

| | WELD | X-RAY | 0.2% PROOF | | ABSORBED ENERGY (J) | | | | |
|---|---|---|---|---|---|---|---|---|---|
| | METAL | TRANSMISSION | STRENGTH (Mpa) | | PWHT1 | | PWHT2 | | |
| SEGMENT | No. | TEST RESULT | PWHT1 | PWHT2 | AVERAGE | MINIMUM | AVERAGE | MINIMUM | EVALUATION |
| PRESENT | 1 | NO DEFECT | 492 | 451 | 219 | 211 | 237 | 232 | ∘ |
| INVENTION | 2 | NO DEFECT | 484 | 445 | 197 | 179 | 205 | 196 | ∘ |
| EXAMPLES | 3 | NO DEFECT | 482 | 443 | 191 | 177 | 206 | 195 | ∘ |
| | 4 | NO DEFECT | 486 | 447 | 212 | 206 | 225 | 219 | ∘ |
| | 5 | NO DEFECT | 488 | 449 | 163 | 154 | 176 | 162 | ∘ |
| | 6 | NO DEFECT | 495 | 454 | 182 | 167 | 195 | 179 | ∘ |
| | 7 | NO DEFECT | 485 | 446 | 203 | 192 | 209 | 195 | ∘ |
| | 8 | NO DEFECT | 512 | 461 | 185 | 169 | 187 | 173 | ∘ |
| | 9 | NO DEFECT | 481 | 442 | 216 | 195 | 218 | 207 | ∘ |
| | 10 | NO DEFECT | 518 | 467 | 168 | 152 | 176 | 164 | ∘ |
| COMPARATIVE | 11 | DEFECT OF | 469 | 428 | 105 | 68 | 175 | 141 | x |
| EXAMPLES | | ROLLED | | | | | | | |
| | 12 | NO DEFECT | 529 | 481 | 124 | 77 | 187 | 138 | x |
| | 13 | DEFECT OF | 484 | 445 | 68 | 52 | 127 | 109 | x |
| | | ROLLED | | | | | | | |
| | 14 | DEFECT OF | 489 | 448 | 85 | 43 | 121 | 98 | x |
| | | ROLLED | | | | | | | |
| | 15 | DEFECT OF | 475 | 434 | 108 | 73 | 132 | 115 | x |
| | | ROLLED | | | | | | | |
| | 16 | DEFECT OF | 538 | 482 | 84 | 49 | 157 | 139 | x |
| | | ROLLED | | | | | | | |
| | 17 | NO DEFECT | 465 | 426 | 132 | 124 | 135 | 129 | x |
| | 18 | NO DEFECT | 534 | 485 | 79 | 62 | 157 | 143 | x |
| | 19 | NO DEFECT | 477 | 438 | 119 | 107 | 185 | 146 | x |
| | 20 | NO DEFECT | 525 | 476 | 106 | 88 | 174 | 146 | x |
| | 21 | NO DEFECT | 487 | 448 | 191 | 71 | 203 | 85 | x |
| | 22 | NO DEFECT | 487 | 448 | 188 | 82 | 199 | 94 | x |
| | 23 | NO DEFECT | 483 | 445 | 173 | 78 | 197 | 82 | x |
| | 24 | NO DEFECT | 495 | 445 | 159 | 64 | 178 | 77 | x |
| | 25 | NO DEFECT | 491 | 452 | 175 | 61 | 193 | 95 | x |
| | 26 | — | — | — | — | — | — | — | x |
| | 27 | — | — | — | — | — | — | — | x |

In Tables 6 and 7, the weld metals No. 1 to 10 are examples of the present invention, while those No. 11 to 27 are comparative examples.

Because the weld metals No. 1 to 10, examples of the present invention, were appropriate in each weld metal component and the bonded fluxes thus combined were also appropriate in their component compositions, high quality weld metals were obtained in which: the 0.2% offset yield strength after the PWHT1 or the PWHT2 were good; the high and stable absorbed energies were obtained; the weldability was good; and there did not occur any weld defect. Thus, extremely satisfactory results were obtained.

Among the comparative examples, in the weld metal No. 11, because the content of CO₂ in the bonded flux F8 thus combined was high, the arc blew up to make the bead shape poor, causing the defect of slag inclusion. Further, because the content of C therein was low, the absorbed energy after the PWHT1 was low and the 0.2% offset yield strength after the PWHT1 or the PWHT2 was low.

In the weld metal No. 12, because the content of CO₂ in the bonded flux F9 thus combined was low, the arc was unstable. Further, because the content of C therein was high, there occurred a crater crack, the 0.2% offset yield strength was high after the PWHT1 or the PWHT2, and the absorbed energy after the PWHT1 was low.

In the weld metal No. 13, because the content of SiO₂ in the bonded flux F10 thus combined was low, the shape at the bead lead was poor, causing the defect of slag inclusion. Further, because the content of Si therein was low, the absorbed energy after the PWHT1 or the PWHT2 was low.

In the weld metal No. 14, because the content of CaF₂ in the bonded flux F11 thus combined was high, the arc was unstable, causing the defect of slag inclusion. Further, because the content of Si therein was high, the absorbed energy after the PWHT1 or the PWHT2 was low.

In the weld metal No. 15, because the content of Al₂O₃ in the bonded flux F12 thus combined was low, the shape at the bead toe was poor, causing the defect of slag inclusion. Further, because the content of Mn therein was also low, the absorbed energy after the PWHT1 or the PWHT2 was low, and the 0.2% offset yield strength thereof was also low.

In the weld metal No. 16, because the content of MgO in the bonded flux F13 thus combined was high, the bead width thereof was narrow, and the slag detachability was poor, causing the defect of slag inclusion. Further, because the content of Mn therein was high, the 0.2% offset yield strength after the PWHT1 or the PWHT2 was high, and the absorbed energy after the PWHT1 was low.

In the weld metal No. 17, because the content of Cr was low, the 0.2% offset yield strength after the PWHT1 or the PWHT2 was low. Further, because the content of V therein was low, the absorbed energy after the PWHT1 or the PWHT2 was slightly low.

In the weld metal No. 18, because the content of Cr was high, 0.2% offset yield strength after the PWHT1 or the PWHT2 was high, and the absorbed energy after the PWHT1 was low.

In the weld metal No. 19, because the content of Mo was low, the 0.2% offset yield strength after the PWHT1 or the PWHT2 was low. Further, because the content of the total of Ti, V and Nb therein was high, the absorbed energy after the PWHT1 was low.

In the weld metal No. 20, because the content of Mo was high, the 0.2% offset yield strength after the PWHT1 or the PWHT2 was high, and the absorbed energy after the PWHT1 was low.

In the weld metal No. 21, because the content of N was high, the minimum absorbed energy after the PWHT1 or the PWHT2 was low.

In each of the weld metals No. 22 to 25, because the content of 0 was high, the minimum absorbed energy after the PWHT1 or the PWHT2 was low. The reasons why these weld metals had a high content of 0 are as follows: in the weld metal 22, the bonded flux F14 thus combined had a low content of MgO; in the weld metal 23, the bonded flux F15 thus combined had a low content of CaF₂; in the weld metal 24, the bonded flux F16 thus combined had a high content of SiO₂; and in the weld metal 25, the bonded flux F17 thus combined had a low content of CaO.

In the weld metal No. 26, because the bonded flux F18 thus combined had a high content of Al₂O₃; and in the weld metal No. 27, because the bonded flux F19 thus combined had a high content of CaO, both bead thereof had a convex shape such that the multi-pass welding could not be carried out. Therefore, the welding operations were halted.

What is claimed is:

1. A submerged arc weld metal for 1.25 Cr-0.5 Mo steel that is obtained by carrying out multi-pass welding in a submerged arc welding process with a solid wire and a bonded flux being combined together, the submerged arc weld metal for 1.25 Cr-0.5 Mo steel comprising, per the total mass of the weld metal:
C: 0.06 to 0.12 mass %;
Si: 0.15 to 0.30 mass %;
Mn: 0.60 to 1.10 mass %;
Cr: 1.10 to 1.45 mass %; and
Mo: 0.45 to 0.60 mass %,
wherein O is contained in an amount of 0.022 mass % or less and N is contained in an amount of 0.008 mass % or less, and wherein the balance is Fe and inevitable impurities.

2. The submerged arc weld metal for 1.25 Cr-0.5 Mo steel according to claim 1, wherein the total of at least one of Ti, V and Nb is contained in an amount of 0.005 to 0.02 mass %.

3. A coke drum produced by the submerged arc weld metal for 1.25 Cr-0.5 Mo steel according to either claim 1 or claim 2.

4. A bonded flux that is to be combined with a solid wire for obtaining the submerged arc weld metal for 1.25 Cr-0.5 Mo steel according to either claim 1 or claim 2, the bonded flux comprising, per the total mass of the flux:
MgO: 25 to 35 mass %;
Al₂O₃: 13 to 20 mass %;
CaF₂: 14 to 22 mass %;
SiO₂: 10 to 19 mass %;
CaO: 6 to 12 mass %; and
a CO₂ conversion value of metal carbonates: 3 to 5 mass %,
wherein the balance is Na₂O, K₂O, an alloy agent, a deoxidizing agent and inevitable impurities.

5. A coke drum produced by a welded construction using the bonded flux according to claim 4
